(19) United States
(12) Patent Application Publication
(10) Pub. No.: US 2006/0238093 A1
(43) Pub. Date: Oct. 26, 2006

(54) Backlight assembly and liquid crystal display apparatus having the same

(75) Inventors: Hae-Il Park, Seoul (KR); Myong-Hi Rhee, Seoul (KR); Seock-Hwan Kang, Suwon-si (KR); Jin-Seob Byun, Seoul (KR); Sang-Yu Lee, Yongin-si (KR)

Correspondence Address: David W. Heid;MacPHERSON KWOK CHEN & HEID LLP, Suite 226, 1762 Technology Drive, San Jose, CA, 95110, US

(73) Assignee: Samsung Electronics Co., Ltd.

(21) Appl. No.: 11/322,709

(22) Filed: Dec. 30, 2005

(30) Foreign Application Priority Data
Apr. 26, 2005 (KR) 2005-34610

(51) Int. Cl. H01J 11/00; H01J 65/00

(52) U.S. Cl. 313/234; 313/581; 313/607

(57) ABSTRACT

A backlight assembly includes a planar fluorescent lamp, a heat-discharge member and a bottom chassis. The planar fluorescent lamp includes a lamp body, a first external electrode and a second external electrode. The lamp body emits light, the first external electrode is formed on an upper face of the lamp body and the second external electrode is formed on a lower face of the lamp body. The heat-discharge member is coupled to the planar fluorescent lamp allowing the heat-discharge member to make contact with the first and second external electrodes. The bottom chassis includes a bottom portion and a side portion to receive the planar fluorescent lamp and makes contact with the heat-discharge member. Thus, the backlight assembly may effectively discharge heat generated from planar fluorescent lamp and prevent a pin-hole defect.

### CROSS REFERENCE TO RELATED APPLICATION

This application claims priority from Korean Patent Application No. 2005-34610 filed on Apr. 26, 2005, the contents of which are herein incorporated by reference in its entirety.

### BACKGROUND OF THE INVENTION

1. Field of the Invention

The present invention relates to a backlight assembly and a liquid crystal display apparatus. More particularly, the present invention relates to a backlight assembly having improved heat-discharge characteristic and a liquid crystal display apparatus having the backlight assembly.

2. Description of the Related Art

In general, a liquid crystal display apparatus displays an image using optical and electrical properties of liquid crystal, such as an anisotropic refractive index, an anisotropic dielectric constant, etc. The liquid crystal display apparatus has characteristics, for example, such as light weight, lower power consumption, lower driving voltage, etc., in comparison with a display apparatus such as a cathode ray tube, a plasma display panel and so on.

The liquid crystal display apparatus requires a backlight assembly since its display panel is not self-emissive. A tubular-shaped cold cathode fluorescent lamp is often used as a light source for the liquid crystal display apparatus. However, in a large-scaled liquid crystal display apparatus, since numbers of the cold cathode fluorescent lamp and manufacturing cost increase, optical properties such as brightness uniformity, etc., are deteriorated.

Recently, in order to reduce the manufacturing cost and enhance the brightness uniformity, a planar fluorescent lamp emitting a planar light has been developed. The planar fluorescent lamp includes a lamp body and an external electrode. The lamp body is divided into a plurality of discharge spaces so as to uniformly emit a light, and the external electrode applies a discharge voltage to the lamp body. When the discharge voltage from an inverter is applied to the external electrode of the planar fluorescent lamp, a plasma discharge is generated in each of the discharge spaces. A fluorescent layer inside the planar fluorescent lamp is excited in response to an ultraviolet light caused by the plasma discharge to generate a visible light.

However, when a high voltage current is applied to the planar fluorescent lamp having the external electrode in order to stably drive the planar fluorescent lamp at an initial time, pin-hole defect where the external electrode and the lamp body are penetrated occurs since a temperature around the external electrode remarkably increases. Moreover, when an optical member such as a diffusing plate is disposed on the planar fluorescent lamp, the pin-hole defect also occurs at an upper face of the planar fluorescent lamp because heat generated from the planar fluorescent lamp is not outwardly discharged.

### SUMMARY OF THE INVENTION

The present invention provides a backlight assembly having improved discharge characteristic of a planar fluorescent lamp and preventing pin-hole defect of the planar fluorescent lamp.

The present invention also provides a liquid crystal display apparatus having the above backlight assembly.

In accordance with one aspect of the present invention, a backlight assembly includes a planar fluorescent lamp, a heat-discharge member and a bottom chassis. The planar fluorescent lamp includes a lamp body to emit light, a first external electrode formed on an upper face of the lamp body and a second external electrode formed on a lower face of the lamp body. The heat-discharge member is coupled to the planar fluorescent lamp such that the heat-discharge member makes contact with the first external electrode and the second external electrode. The bottom chassis includes a bottom portion and a side portion to receive the planar fluorescent lamp and makes contact with the heat-discharge member. The first and second external electrodes are connected to each other along a side face of the lamp body. The heat-discharge member covers the upper face, the lower face and a side face of the planar fluorescent lamp. The heat-discharge member makes contact with the side portion and the bottom portion of the bottom chassis.

In accordance with another aspect of the present invention, a backlight assembly includes a planar fluorescent lamp, a bottom chassis and a heat-discharge member. The planar fluorescent lamp includes a lamp body to emit light, a first external electrode formed on an upper face of the lamp body and a second external electrode formed on a lower face of the lamp body. The bottom chassis has a bottom portion and a side portion to receive the planar fluorescent lamp. The heat-discharge member makes contact with the first external electrode and the side portion of the bottom chassis.

In accordance with still another aspect of the present invention, a liquid crystal display apparatus includes a backlight assembly to generate light and a display unit. The backlight assembly includes a planar fluorescent lamp, a heat-discharge member and a bottom chassis. The planar fluorescent lamp includes a lamp body to emit light, a first external electrode formed on an upper face of the lamp body, and a second external electrode formed on a lower face of the lamp body. The heat-discharge member is coupled to the planar fluorescent lamp such that the heat-discharge member makes contact with the first external electrode and the second external electrode. The bottom chassis includes a bottom portion and a side portion to receive the planar fluorescent lamp and makes contact with the heat-discharge member. The display unit displays an image using the light generated by the backlight assembly.

In accordance with further still another aspect of the present invention, a liquid crystal display apparatus includes a backlight assembly and a display unit. The backlight assembly includes a planar fluorescent lamp, a bottom chassis and a heat-discharge member. The planar fluorescent lamp includes a lamp body to emit light, a first external electrode formed on an upper face of the lamp body, and a second external electrode formed on a lower face of the lamp body. The bottom chassis includes a bottom portion and a side portion to receive the planar fluorescent lamp. The heat-discharge member makes contact with the first external electrode and the side portion of the bottom chassis. The display unit displays an image using the light generated by the backlight assembly.

According to the backlight assembly and the liquid crystal display apparatus, the backlight assembly may effectively discharge heat generated from planar fluorescent lamp and prevent a pin-hole defect.

### BRIEF DESCRIPTION OF THE DRAWINGS

The above and other advantages of the present invention will become readily apparent by reference to the following detailed description when considered in conjunction with the accompanying drawings wherein:

FIG. 1 is an exploded perspective view showing a backlight assembly according to a first embodiment of the present invention;

FIG. 2 is a cross-sectional view of the backlight assembly in FIG. 1 in an assembled state and taken along line 2-2 of FIG. 1;

FIG. 3 is a cross-sectional view of an edge portion of a backlight assembly according to a second embodiment of the present invention;

FIG. 4 is a cross-sectional view of an edge portion of a backlight assembly according to a third embodiment of the present invention;

FIG. 5 is a cross-sectional view of an edge portion of a backlight assembly according to a fourth embodiment of the present invention;

FIG. 6 is an exploded perspective view showing a backlight assembly according to a fifth embodiment of the present invention;

FIG. 7 is a cross-sectional view of the backlight assembly in FIG. 6 in an assembled state and taken along line 7-7 of FIG. 6;

FIG. 8 is a cross-sectional view showing a similar portion of a backlight assembly according to a sixth embodiment of the present invention;

FIG. 9 is a perspective view showing a planar fluorescent lamp for the backlight assemblies in FIGS. 1 to 6;

FIG. 10 is a cross-sectional view taken along a line 10-10 of FIG. 10; and

FIG. 11 is an exploded perspective view showing a liquid crystal display apparatus according to a seventh embodiment of the present invention.

### DESCRIPTION OF THE EMBODIMENTS

Hereinafter, the present invention will be explained in detail with reference to the accompanying drawings.

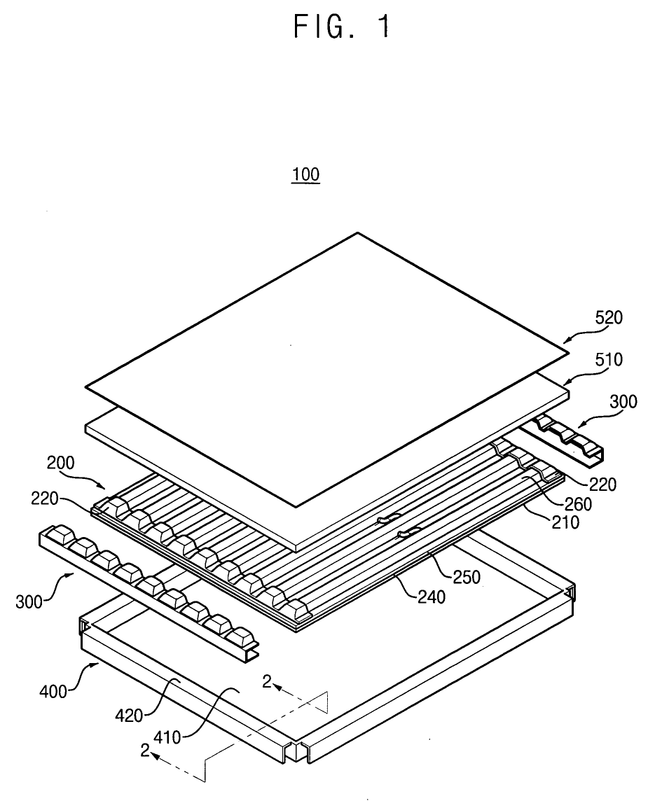

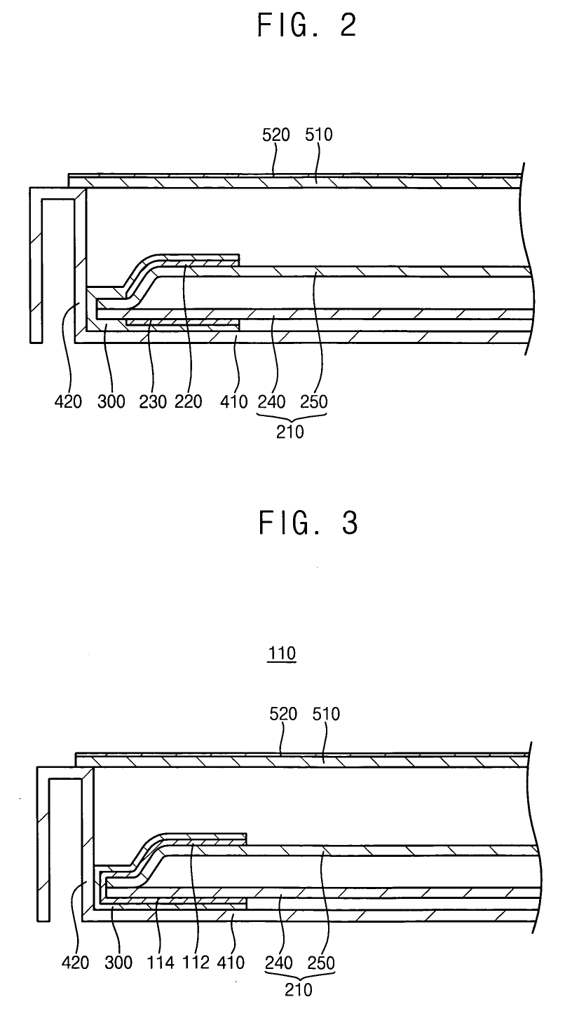

FIG. 1 is an exploded perspective view showing a backlight assembly according to a first embodiment of the present invention. FIG. 2 is a cross-sectional view taken along line 2-2 of the backlight assembly in FIG. 1.

Referring to FIGS. 1 and 2, a backlight assembly 100 according to a first embodiment of the present invention includes a planar fluorescent lamp 200, a heat-discharge member 300 and a bottom chassis 400.

The planar fluorescent lamp 200 includes a lamp body 210 emitting light, a first external electrode 220 formed on an upper face of the lamp body 210 and a second external electrode 230 formed on a lower face of the lamp body 210.

The lamp body 210 includes a first substrate 240 and a second substrate 250 coupled to the first substrate 240 to form a plurality of discharge spaces 260. In order to emit the light in a planar shape, the lamp body 210 has a generally rectangular shape when viewed from an upper portion of the lamp body 210. The lamp body 210 generates plasma discharge in the discharge spaces 260 in response to a discharge voltage applied to the first and second external electrodes 220 and 230 from an external inverter (not shown), and emits a visible light after the lamp body 210 converts an ultraviolet light generated by the plasma discharge into the visible light. In order to improve light emitting efficiency, an inner space of the lamp body 210 is divided into the discharge spaces 260.

The first external electrode 220 is formed on an outer face of the second substrate 250. The second external electrode 230 is formed on an outer face of the first substrate 240. The first and second external electrodes 220 and 230 are formed in a direction intersecting with the discharge spaces 260 to apply the discharge voltage to the discharge spaces 260. The first and second external electrodes 220 and 230 are formed at both ends of the discharge spaces 260, respectively.

The heat-discharge member 300 is coupled to the planar fluorescent lamp 200 to allow the heat-discharge member 300 to make contact with the first and second external electrodes 220 and 230. The heat-discharge member 300 covers the upper face on which the first external electrode 220 is formed, a side face and the lower face on which the second external electrode 230 is formed.

The heat-discharge member 300 is constructed using a material having a high heat conductivity characteristic to allow heat generated by the planar fluorescent lamp 200 to be conducted to the bottom chassis 400. In the present embodiment, the heat-discharge member 300 is constructed from a material having a heat conductivity of about 3 watts per metre-kelvin [W/(m·K)] or greater. The heat-discharge member 300 may include an insulating material into which a small amount of heat conductivity powder such as carbon (C) or aluminum (Al) is mixed.

The heat-discharge member 300 may have a viscosity such that the heat-discharge member 300 is cohered with the first and second external electrodes 220 and 230 since heat discharge efficiency of the heat-discharge member 300 may be improved as the heat-discharge member 300 is more firmly cohered with the first and second external electrodes 220 and 230. Further, the heat-discharge member 300 may have elasticity to buffer an impact applied from an exterior.

The bottom chassis 400 includes a bottom portion 410 and a side portion 420 which extends from an edge of the bottom portion 410 to provide a receiving space for the planar fluorescent lamp 200. The bottom chassis 400 is constructed from a metal material having high strength and high heat conductivity.

The planar fluorescent lamp 200 to which the heat-discharge member 300 is coupled is received in the bottom chassis 400 such that the heat-discharge member 300 makes contact with the bottom chassis 400. The heat-discharge member 300 makes contact with the bottom portion 410 and the side portion 420 of the bottom chassis 400. The heat generated from the first and second external electrodes 220 and 230 is conducted to the bottom chassis 400 through the heat-discharge member 300 and outwardly discharged from the bottom of chassis 410.

The backlight assembly 100 may further include a diffusion plate 510 disposed on the planar fluorescent lamp 200 and at least one optical sheet 520 disposed on the diffusion plate 510.

The diffusion plate 510 diffuses the light emitted from the planar fluorescent lamp 200 to enhance brightness uniformity of the light. The diffusion plate 510 has a plate-like shape with a predetermined thickness and is spaced apart from the planar fluorescent lamp 200. Diffusion plate 510 may be constructed from materials such as polymethylmethacrylate (PMMA) and a diffusing agent mixed with polymethylmethacrylate.

The optical sheet 520 changes an advancing path of the light diffused by the diffusion plate 510 to improve the brightness characteristics of the light. The optical sheet 520 may include a condensing sheet that condenses the diffused light by the diffusion plate 510 to a front direction, thereby enhancing front brightness of the light. The optical sheet 520 may further include a diffusing sheet that diffuses the light that is diffused by the diffusion plate 510, thereby enhancing the brightness uniformity of the light. In accordance with the brightness characteristics of the backlight assembly 100, various optical sheets may be applied as the optical sheet 520.

FIG. 3 is a cross-sectional view showing a backlight assembly according to a second embodiment of the present invention. The back light assembly 110 in FIG. 3 includes elements common to the back light assembly 100 shown in FIGS. 1 and 2, with the exception of the first and second external electrodes. Thus, in FIG. 3, the same reference numerals will be used to refer to the same elements as in FIGS. 1 and 2.

Referring to FIG. 3, a backlight assembly 110 includes according to a second embodiment of the present invention planar fluorescent lamp 200, heat-discharge member 300, bottom chassis 400, diffusion plate 510 and optical sheet 520.

The planar fluorescent lamp 200 includes lamp body 210 emitting light, first external electrode 112 formed on an upper face of the lamp body 210 and a second external electrode 114 formed on a lower face of the lamp body 210.

The first external electrode 112 is formed on an outer face of the second substrate 250. The second external electrode 114 is formed on an outer face of the first substrate 240. The first and second external electrodes 112 and 114 are formed in a direction intersecting with the discharge spaces to apply the discharge voltage to the discharge spaces. The first and second external electrodes 112 and 114 respectively are formed at both ends of the discharge spaces, respectively.

In the back light assembly as shown in FIG. 3, the first external electrode 112 and the second external electrode 114 are connected with each other along a side face of the lamp body 210. Thus, an area where the first and second external electrodes 112 and 114 make contact with the heat-discharge member 300 may be increased, so that the backlight assembly 110 according to the second embodiment of the present invention may have an enhanced heat discharge efficiency compared with the backlight assembly 100 according to the first embodiment of the present invention.

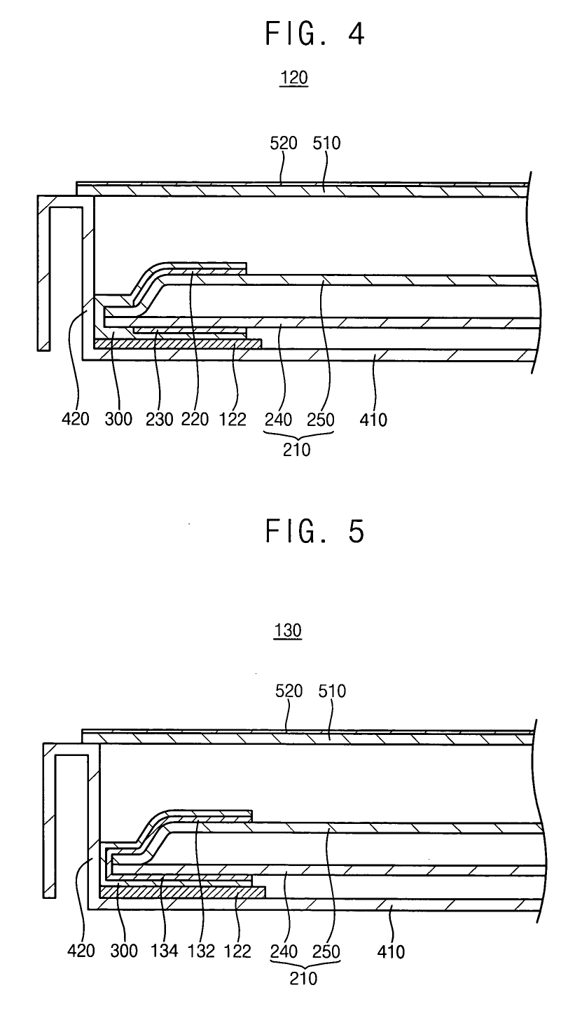

FIG. 4 is a cross-sectional view showing backlight assembly 120 according to a third embodiment of the present invention. The back light assembly 120 in FIG. 4 includes the same elements as in the back light assembly in FIGS. 1 and 2, with the exception of the addition of buffer member 122. Thus, in FIG. 4, the same reference numerals will be used to refer to the same elements as in FIGS. 1 and 2.

Referring to FIG. 4, a backlight assembly 120 includes according to a third embodiment of the present invention includes planar fluorescent lamp 200, heat-discharge member 300, bottom chassis 400, diffusion plate 510, optical sheet 520 and buffer member 122.

The buffer member 122 is disposed between the planar fluorescent lamp 200 and the bottom chassis 400. More particularly, the buffer member 122 is disposed between the heat-discharge member 300 and bottom portion 410 of bottom chassis 400. The buffer member 122 allows the planar fluorescent lamp 200 to be spaced apart from the bottom chassis 400, thereby electrically insulating the planar fluorescent lamp 200 from the bottom chassis 400. The buffer member 122 is comprised of an elastic material to absorb a force of an impact applied from an exterior. Buffer member 122 may be constructed from a material which includes silicon to provide electrical insulation and provide the buffer function for the planar fluorescent lamp 200.

In the backlight assembly in FIG. 4, heat-discharge member 300 makes contact with only side portion 420 of the bottom chassis 400 since the buffer member 122 is applied to the backlight assembly 120.

In order to enhance its heat discharge efficiency, the buffer member 122 includes heat conductive material for transferring heat between the heat-discharge member 300 and the bottom chassis 400. In the present embodiment, the buffer member 122 has a heat conductivity of not less than about 3 W/(m·K). The buffer member 122 may include an insulating material such as silicon into which heat conductivity powder such as carbon (C) or aluminum (Al) is mixed.

Thus, the backlight assembly 120 according to the third embodiment exhibits both a high heat discharge efficiency and high impact resistance.

FIG. 5 is a cross-sectional view showing backlight assembly 130 according to a fourth embodiment of the present invention. The back light assembly 130 is constructed of the same elements as in the back light assembly in FIGS. 1 and 2 except for the first and second external electrodes. Thus, in FIG. 5, the same reference numerals are used to refer to the same elements as in FIGS. 1 and 2.

Referring to FIG. 5, a backlight assembly 130 includes according to this fourth embodiment of the present invention includes a planar fluorescent lamp 200, heat-discharge member 300, bottom chassis 400, diffusion plate 510, optical sheet 520 and buffer member 122.

The planar fluorescent lamp 200 includes a lamp body 210 emitting light, a first external electrode 132 formed on an upper face of the lamp body 210 and a second external electrode 134 formed on a lower face of the lamp body 210.

The first external electrode 132 is formed on an outer face of the second substrate 250. The second external electrode 134 is formed on an outer face of the first substrate 240.

In the backlight assembly 130 in FIG. 5, the first external electrode 132 and the second external electrode 134 are connected to each other along a side face of the lamp body 210. Thus, an area where the first and second external electrodes 112 and 114 make contact with the heat-discharge member 300 is increased, thus the backlight assembly 130 according to the fourth embodiment of the present invention provides an enhanced heat discharge efficiency and an superior impact resistance.

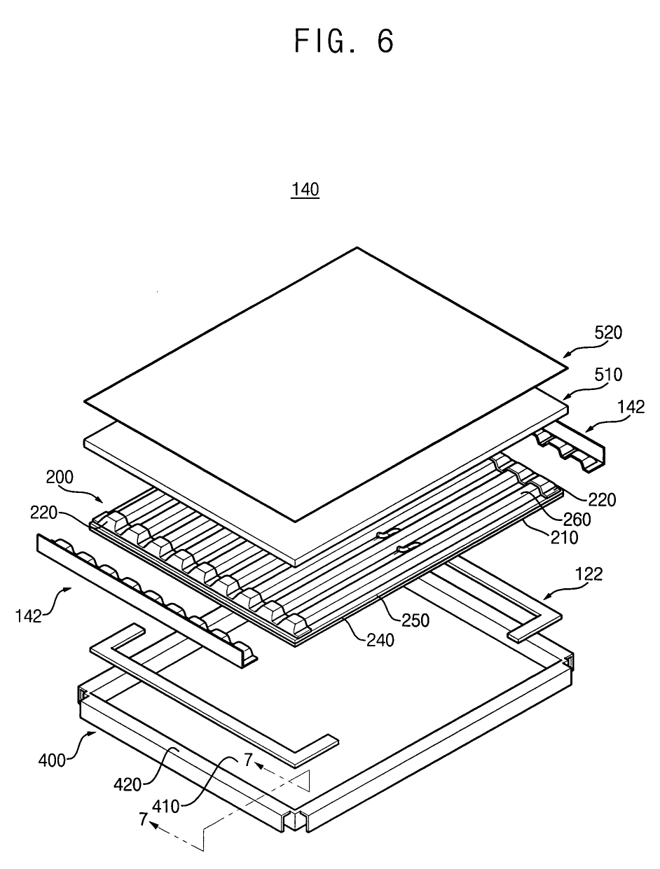

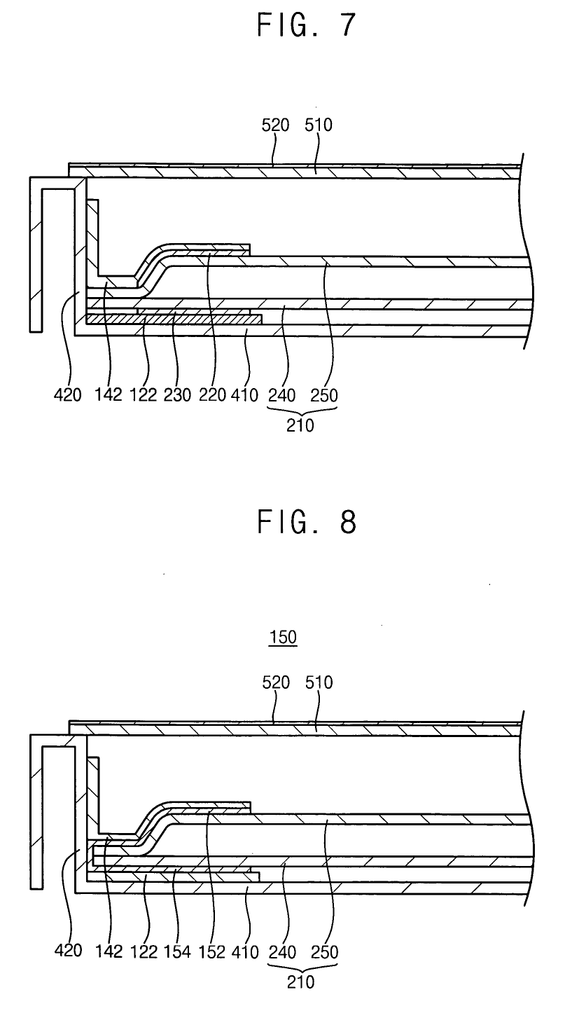

FIG. 6 is an exploded perspective view showing backlight assembly 140 according to a fifth embodiment of the present invention. FIG. 7 is a cross-sectional view taken along line 7-7 of FIG. 6. Back light assembly 140 in FIGS. 6 and 7 includes the same elements as in the back light assembly in FIG. 4 except for the heat-discharge member. Thus, in FIGS. 6 and 7, the same reference numerals denote the same elements as in FIG. 4.

Referring to FIGS. 6 and 7, a backlight assembly 140 according to a fifth embodiment of the present invention includes a planar fluorescent lamp 200, heat-discharge member 142, bottom chassis 400, diffusion plate 510, an optical sheet 520 and buffer member 122.

The heat-discharge member 142 is disposed such that the heat-discharge member 142 makes contact with the first external electrode 220 and the side portion 420 of the bottom chassis 400. The heat-discharge member 142 includes a material having high heat conductivity to transmit the heat generated from the first external electrode 220 of the planar fluorescent lamp 200 to bottom chassis 400. Heat-discharge member 142 has the heat conductivity of at least about 3 W/(m·K) or greater. Heat-discharge member 142 may include an insulating material into which heat conductive powder, such as carbon (C) or aluminum (Al), is mixed. To increase heat discharge efficiency of the heat-discharge member 142, it is desirable that heat-discharge member 142 adhere to first external electrode 220. This can be achieved by constructing the heat-discharge member 142 from a viscous material.

Thus, the heat generated from the first external electrode 220 is transmitted to the bottom chassis 400 through the heat discharge member 142 and outwardly discharged from the bottom chassis 400.

In backlight assembly 140 of FIGS. 6 and 7, the planar fluorescent lamp 200 may be electrically insulated from the bottom chassis 400 by buffer member 122 and accordingly have enhanced impact resistance.

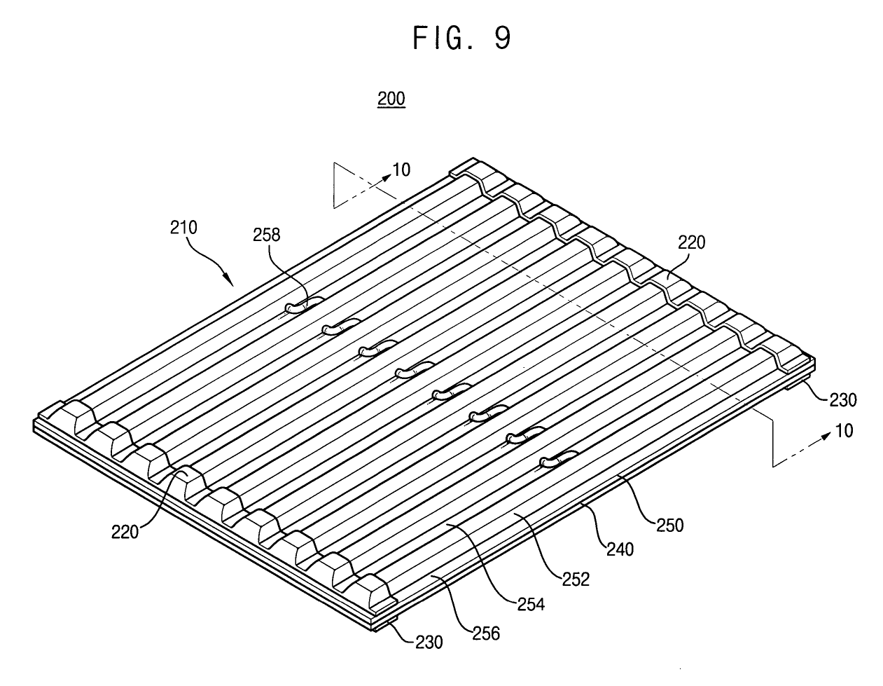

FIG. 8 is a cross-sectional view showing a backlight assembly according to a sixth embodiment of the present invention. The back light assembly 150 shown in FIG. 8 includes elements common to back light assembly 100 in FIGS. 1 and 2, with the exception of the first and second external electrodes. Thus, in FIG. 8, the same reference numerals will be used to refer to the same elements as in FIGS. 1 and 2, and any further repetitive descriptions of the same elements will be omitted.

Referring to FIG. 8, a backlight assembly 150 includes according to a sixth embodiment of the present invention includes planar fluorescent lamp 200, heat-discharge member 142, bottom chassis 400, diffusion plate 510, optical sheet 520 and buffer member 122.

The planar fluorescent lamp 200 includes a lamp body 210 emitting light, first external electrode 152 formed on an upper face of the lamp body 210 and second external electrode 154 formed on a lower face of the lamp body 210.

First external electrode 152 is formed on an outer face of the second substrate 250. Second external electrode 154 is formed on an outer face of the first substrate 240.

In the backlight assembly 150 of FIG. 8, first external electrode 152 and second external electrode 154 are connected with each other along a side face of the lamp body 210. Thus, the area where the first external electrode 152 makes contact with the heat-discharge member 142 is increased, and the connected portion between the first and second external electrodes 152 and 154 makes contact with the side portion 420 of the bottom chassis 400. Thus, the backlight assembly 150 according to the sixth embodiment of the present invention achieves the enhanced heat discharge efficiency and the enhanced impact resistance like the backlight assembly 140 according to the fifth embodiment of the present invention.

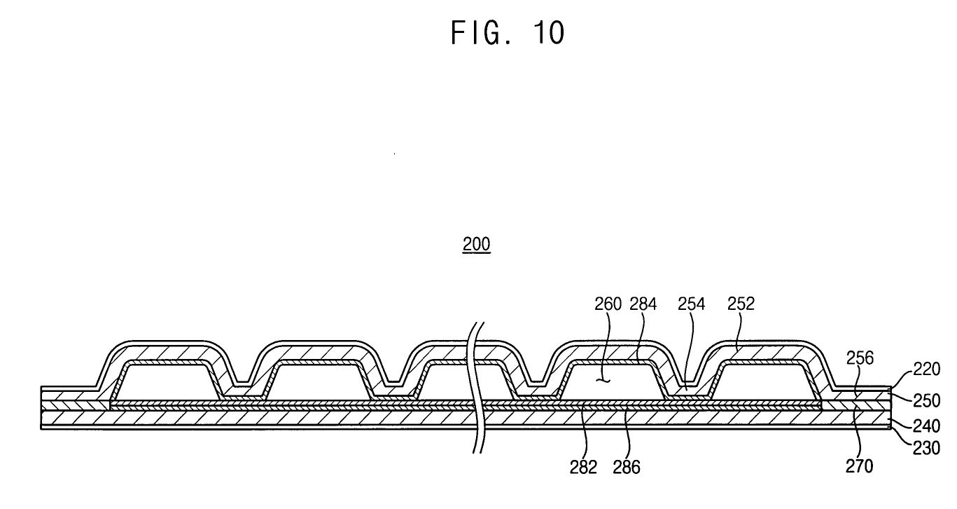

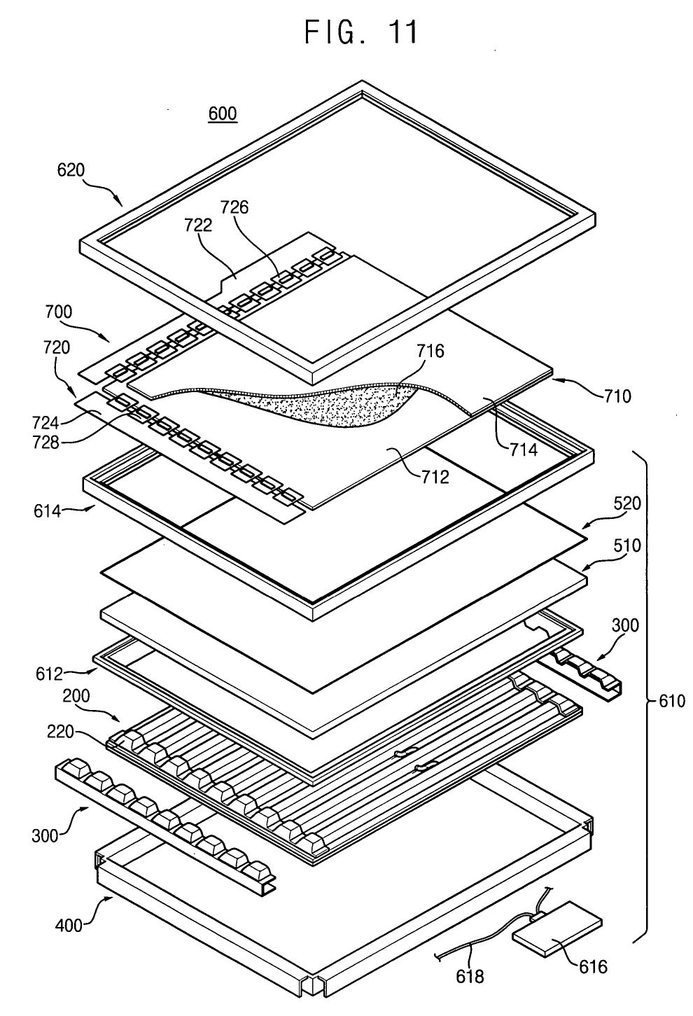

FIG. 9 is a perspective view showing a planar fluorescent lamp 200 for the backlight assemblies as in FIGS. 1 to 8. FIG. 10 is a cross-sectional view taken along a line 10-10 of FIG. 9.

Referring to FIGS. 9 and 10, the planar fluorescent lamp 200 includes a lamp body 210 emitting light, first external electrode 220 formed on an upper face of the lamp body 210 and second external electrode 230 formed on a lower face of the lamp body 210.

The lamp body 210 includes a first substrate 240 and a second substrate 250 combined with the first substrate 240 to form a plurality of discharge spaces 260 between the first and second substrates 240 and 250.

The first substrate 240 has a rectangular plate shape. The first substrate 240 includes a glass material. The first substrate 240 may also include a light blocking material to prevent leakage of ultraviolet light generated in the discharge spaces 260.

The second substrate 250 is formed by a process including a mold to form the discharge spaces 260. The second substrate 250 includes a transparent material through which visible light generated in the discharge spaces 260 is transmitted. For example, the second substrate 250 includes a glass material. The second substrate 250 also may include a light blocking material to prevent leakage of ultraviolet light generated in the discharge spaces 260.

The second substrate 250 may be formed through various molding processes. That is, when a glass substrate having a same plate-like shape as the first substrate 240 is heated at a predetermined temperature and molded through a frame, the second substrate 250 is formed as shown in FIGS. 9 and 10. Other than the above, the second substrate 250 may be formed in such a manner that the glass substrate having the plate-like shape is heated and injected with an air.

The molded second substrate 250 includes a plurality of discharge portions 252, a plurality of space-dividing portions 254 and a sealing portion 256. The discharge space portions 252 are spaced apart from the first substrate 240 to form the discharge spaces 260. The space-dividing portions 254 are disposed between the discharge space portions 252 and make contact with the first substrate 240 to divide the discharge spaces 260. The sealing portion 256 is formed at an end portion of the second substrate 250 and combines the second substrate 250 with the first substrate 240. The second substrate 250 has a cross-sectional profile that a plurality of arches arranged one after another as shown in FIG. 10. However, the second substrate 250 may have various cross-sectional profiles, for example, a semicircle, a square, a trapezoid, etc.

The second substrate 250 has hollow tube-like connection paths 258 to connect adjacent discharge spaces 260 to each other. At least one connection path 258 is formed at each of the space-dividing portions 254. The connection path 258 provides a passage for an air in the discharge spaces 260 to be vented or a discharge gas to be injected into the discharge spaces 260. The connection path 258 is simultaneously formed with the second substrate 250 by the molding process. The connection path 258 may have various shapes, for example, an S-shape. When the connection path 258 has the S-shape, the planar fluorescent lamp 200 may effectively prevent drift between the discharge spaces 260 due to an elongated connection path 258 through which the discharge gas is flowed.

The second substrate 250 is coupled to the first substrate 240 by means of an adhesive 270 such as a frit having a melting point lower than that of a glass. That is, the adhesive 270 is disposed between the first and second substrates 240 and 250 correspondingly to the sealing portion 256, and then the adhesive 270 is fired, to thereby combine the first substrate 240 with the second substrate 250. In the present embodiment, the combination of the first and second substrates 240 and 250 is carried out at a temperature from about four hundred degrees Celsius to about six hundred degrees Celsius.

The space-dividing portions 254 of the second substrate 250 adhere to the first substrate 240 due to a pressure difference between an inner space and an outer space of the lamp body 210. Particularly, when the first and second substrates 240 and 250 are coupled to each other and the air in the discharge spaces 260 is vented, the inner spaces of the discharge spaces 260 are maintained in a vacuum state. Various discharge gases are injected into the discharge spaces 260 to achieve plasma discharge in the discharge spaces 260. In the present embodiment, examples of the discharge gas may have mercury (Hg), neon (Ne), and argon (Ar). In the present embodiment, a gas pressure of the discharge spaces 260 is maintained within a range from about fifty torr to about seventy torr lower than an atmospheric pressure of about seven hundreds sixty torr. Due to a pressure difference between the gas pressure of the discharge spaces 260 and the atmospheric pressure, force is applied to the planar fluorescent lamp 200 toward the discharge spaces 260, so that the space-dividing portions 254 are cohered to the first substrate 240.

The planar fluorescent lamp 200 further includes a first fluorescent layer 282 formed on an inner face of the first substrate 240 and a second fluorescent layer 284 formed on an inner face of the second substrate 250 facing the inner face of the first substrate 240. The first and second fluorescent layers 282 and 284 are excited in response to the ultraviolet light that is generated by the plasma discharge of the discharge spaces 260 resulting in the emission of visible light.

The planar fluorescent lamp 200 further includes a reflecting layer 286 formed between the first substrate 240 and the first fluorescent layer 282. The reflecting layer 286 reflects the visible light emitted from the first and second fluorescent layers 282 and 284 toward the second substrate 240, thereby preventing the light from leaking through the first substrate 240. In the present embodiment, the materials which may be used to produce reflecting layer 286 include a metal oxide material such as aluminum oxide (Al₂O₃), or barium sulfate (BsSO₄).

The first fluorescent layer 282, the second fluorescent layer 284 and the reflecting layer 286 are formed on the first and second substrates 240 and 250 in a spray manner. The first fluorescent layer 282, the second fluorescent layer 284 and the reflecting layer 286 are formed over the first and second substrates 240 and 250 except for an area on which the sealing portion 256 is formed. Although not shown in FIGS. 9 and 10, the first fluorescent layer 282, the second fluorescent layer 284 and the reflecting layer 286 may be removed from an area corresponding to the space-dividing portions 254.

The planar fluorescent lamp 200 may further include a passivation layer (not shown) formed between the first substrate 240 and the reflecting layer 286 and/or between the second substrate 250 and the second fluorescent layer 284. The passivation layer prevents a chemical reaction between the first and second substrates 240 and 250 and the discharge gas such as the mercury (Hg), thereby preventing a loss of the mercury and blackening of the lamp body 200.

The first external electrode 220 and the second external electrode 230 are formed on the upper face and the lower face of the lamp body 210, respectively. The first and second external electrodes 220 and 230 are formed at both ends of the planar fluorescent lamp 200 in a substantially perpendicular direction to a longitudinal direction of the discharge spaces 260, respectively. The first and second electrodes 220 and 230 formed on the upper face and the lower face of the lamp body 210, respectively, may be electrically connected to each other by means of a connection member such as a conductive clip (not shown). Alternatively, in order to enhance the heat-discharge efficiency, the first and second electrodes 220 and 230 may be coupled to each other along the end portion of the lamp body 210.

The first and second external electrodes 220 and 230 include a conductive material to apply a discharge voltage from an external inverter to the lamp body 210. In the present embodiment, the first and second external electrodes 220 and 230 include a silver paste having silver (Ag) and silicon oxide (SiO₂), metal or metal composition. The first and second external electrodes 220 and 230 may be formed through one of methods of spraying, spin coating and dipping. Further, the first and second external electrodes 220 and 230 may be formed using a metal socket.

As another embodiment, the lamp body may include the second substrate having the same plate-like shape as the first substrate. In case that the second substrate has the plate-like shape, a plurality of space-dividing walls is disposed between the first substrate and the second substrate in order to divide the discharge space.

FIG. 11 is an exploded perspective view showing a liquid crystal display apparatus 600 according to a seventh embodiment of the present invention.

Referring to FIG. 11, a liquid crystal display apparatus 600 according to a seventh embodiment of the present invention includes a backlight assembly 610 supplying the light and a display unit 700 for displaying an image using the light supplied from the backlight assembly 610.

In FIG. 11, the backlight assembly 610 may include same parts as those of first to sixth embodiments shown in FIGS. 1 to 10 except for a first frame 612, a second frame 614 and an inverter 616. Thus, the same reference numerals in FIG. 11 will be used to refer to the same elements in FIGS. 1 and 2, and thus any further repetitive descriptions of the same elements will be omitted.

The backlight assembly 610 may further include a first frame 612 disposed between the planar fluorescent lamp 200 and the diffusion plate 510. The first frame 612 holds the end portion of the planar fluorescent lamp 200 and supports end portions of the diffusion plate 510 and the optical sheet 520. The first frame 612 pressurizes the heat-discharge member 300 such that the heat-discharge member 300 is cohered to the first external electrode 220 of the planar fluorescent lamp 200. In the present embodiment, the first frame 612 has a shape much like a picture frame. The first frame 612 may be constructed of two pieces, each having a substantially U shape, or a substantially L shape, or from four pieces, each corresponding to sides of the planar fluorescent lamp 200, respectively. Other combinations of shape may also be used.

The backlight assembly 610 may further a second frame 614 disposed between the optical sheet 520 and the display unit 700. The second frame 614 holds end portions of the diffusion plate 510 and the optical sheet 520 and substantially simultaneously supports end of the liquid crystal display panel 710. In the present embodiment, the second frame 614 also has a shape much like a picture frame. The second frame 614 also may be constructed using two pieces or four pieces.

The backlight assembly 610 may further include an inverter 616 to apply the discharge voltage to the planar fluorescent lamp 200. The inverter 616 is outside the bottom chassis 400. The inverter 616 generates the discharge voltage to drive the planar fluorescent lamp 200. The inverter 616 boosts an incoming alternating current voltage of a low voltage level to provide an output of an alternating current voltage at a high voltage level to provide the discharge voltage. The discharge voltage generated by the inverter 616 is applied to the first and second external electrodes 220 and 230 through a power line 618.

The display unit 700 includes a liquid crystal display panel 710 that displays an image using the light from the backlight assembly 610 and a driving circuit 720 that drives the liquid crystal display panel 710.

The liquid crystal display panel 710 includes a first substrate 712, a second substrate 714 facing the first substrate 712 and a liquid crystal layer 716 disposed between the first and second substrates 712 and 714.

The first substrate 712 is a TFT substrate on which TFTs are formed in a matrix. The first substrate 712 includes a glass. Each of the TFTs has a source connected to a data line, a gate connected to a gate line and a drain connected to a pixel electrode (not shown) that is a transparent and conductive material.

The second substrate 714 is a color filter substrate on which RGB pixels (not shown) are formed by a thin film process. The second substrate 714 also includes the glass. The second substrate 714 includes a common electrode (not shown) formed thereon. The common electrode includes a transparent conductive material.

When power is applied to the gate of the TFT and the TFT is turned on, an electric field is generated between the pixel electrode and the common electrode. The electric field varies an aligning angle of liquid crystal molecules of the liquid crystal layer 716 interposed between the first substrate 712 and the second substrate 714. Thus, a light transmittance of the liquid crystal layer 716 is varied in accordance with the variation of the aligning angle of the liquid crystal, so a desired image may be obtained.

The driving circuit 720 includes a data printed circuit board 722 that applies a data driving signal to the liquid crystal display panel 710, a gate printed circuit board 724 that applies a gate driving signal to the liquid crystal display panel 710, a data driving circuit film 726 that electrically connects the data printed circuit board 722 to the liquid crystal display panel 710 and a gate driving circuit film 728 that electrically connects the gate printed circuit board 724 to the liquid crystal display panel 710. The data and gate driving circuit films 726 and 728 include a tape carrier package (TCP) or a chip-on-film (COF). In case that separated signal lines are formed on the liquid crystal display panel 710 and the gate driving circuit film 728, the gate printed circuit board 724 may be removed from the liquid crystal display apparatus 600.

The liquid crystal display apparatus 600 may further include a top chassis 620 to fix the display unit 700 to backlight assembly 610. The top chassis 620 is coupled to the bottom chassis 400 to fix an end of the liquid crystal display panel 710 to the backlight assembly 600. The data printed circuit board 722 is bent by means of the data driving circuit film 726 such that the data printed circuit board 722 is fixed to a side portion or a bottom portion of the bottom chassis 400. The top chassis 620 includes a metal having a superior strength.

According to the above, the liquid crystal display apparatus includes the heat-discharge member making contact with the external electrodes and the bottom chassis of the planar fluorescent lamp, thereby effectively discharge the heat generated from the external electrodes of the planar fluorescent lamp and preventing the pin-hole defect of the external electrodes.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A backlight assembly comprising:
a planar fluorescent lamp comprising:
a lamp body;
a first external electrode formed on an upper face of the lamp body; and
a second external electrode formed on a lower face of the lamp body;
a heat-discharge member associated with the planar fluorescent lamp such that the heat-discharge member contacts with at least one of the first and second external electrodes.

2. The backlight assembly of claim 1, wherein the first external electrode and the second external electrode are connected to each other along an edge of the lamp body.

3. The backlight assembly of claim 1, wherein the heat-discharge member is comprised of carbon.

4. The backlight assembly of claim 1, wherein a heat conductivity of the heat-discharge member is about 3 W/(m·K) or greater.

5. The backlight assembly of claim 1, wherein the heat-discharge member covers an upper face, a lower face and a side face of the planar fluorescent lamp.

6. The backlight assembly of claim 1, wherein the backlight assembly further includes a chassis, and wherein the heat-discharge member makes contact with the chassis.

7. The backlight assembly of claim 1, wherein the backlight assembly includes a chassis having a bottom portion and a side portion associated with the bottom portion and further wherein the heat-discharge member makes contact with the side portion and the bottom portion of the chassis.

8. The backlight assembly of claim 1, wherein the backlight assembly further includes a chassis, the backlight assembly comprising a buffer member disposed between the heat-discharge member and chassis.

9. The backlight assembly of claim 8, wherein a heat conductivity of the buffer member is about 3 W/(m·K) or greater.

10. The backlight assembly of claim 1, wherein the lamp body comprises:
a first substrate; and
a second substrate combined with the first substrate to provide a plurality of light discharge spaces.

11. The backlight assembly of claim 10, wherein the first external electrode and the second external electrode are formed such that the first and second external electrodes intersect with the discharge spaces.

12. The backlight assembly of claim 1, further comprising:
a diffusion plate associated with the planar fluorescent lamp to diffuse light emitted from the planar fluorescent lamp; and
at least one optical sheet positioned on the diffusion plate.

13. The backlight assembly of claim 1, wherein the bottom chassis makes contact with the heat-discharge member.

14. A backlight assembly comprising:
a planar fluorescent lamp comprising:
a lamp body to emit light;
a first external electrode formed on an upper face of the lamp body; and
a second external electrode formed on a lower face of the lamp body;
a bottom chassis having a bottom portion and a side portion to receive the planar fluorescent lamp; and
a heat-discharge member positioned in contact with the first external electrode and the side portion of the bottom chassis.

15. The backlight assembly of claim 14, wherein the heat-discharge member comprises carbon.

16. The backlight assembly of claim 14, wherein a heat conductivity of the heat-discharge member is about 3 W/(m·K) or greater.

17. The backlight assembly of claim 14, wherein the first external electrode and the second external electrode are connected to each other along a side face of the lamp body.

18. A liquid crystal display apparatus comprising:
a backlight assembly to generate light; and
a display unit to display an image using the light generated by the backlight assembly,
the backlight assembly comprising:
a lamp body;
a first external electrode formed on an upper face of the lamp body; and
a second external electrode formed on a lower face of the lamp body;
a heat-discharge member associated with the planar fluorescent lamp such that the heat-discharge member contacts with at least one of the first and second external electrodes.

19. The liquid crystal display apparatus of claim 18, wherein the heat-discharge member covers the upper face, the lower face and a side face of the planar fluorescent lamp.

20. The liquid crystal display apparatus of claim 18, wherein the first external electrode and the second external electrode are connected to each other along a side face of the lamp body.

21. The liquid crystal display apparatus of claim 18, wherein the heat-discharge member comprises carbon, and further wherein a heat conductivity of the heat-discharge member is about 3 W/(m·K) or greater.

22. The liquid crystal display apparatus of claim 18, wherein the heat-discharge member makes contact with the side portion of the bottom chassis.

23. The liquid crystal display apparatus of claim 18, wherein the heat-discharge member makes contact with the side portion and the bottom portion of the bottom chassis.

24. The liquid crystal display apparatus of claim 18, wherein the display unit comprises:
a liquid crystal display panel to display the image; and
a driving circuit to drive the liquid crystal display panel.

25. The liquid crystal display apparatus of claim 18, wherein the bottom chassis makes contact with the heat-discharge member.

26. A liquid crystal display apparatus comprising:
a backlight assembly to generate light; and
a display unit to display an image using the light generated by the backlight assembly,
the backlight assembly comprising:
a planar fluorescent lamp having a lamp body to emit light, a first external electrode formed on an upper face of the lamp body, and a second external electrode formed on a lower face of the lamp body,
a bottom chassis having a bottom portion and a side portion to receive the planar fluorescent lamp; and
a heat-discharge member making contact with the first external electrode and the side portion of the bottom chassis.

27. The liquid crystal display apparatus of claim 26, wherein the heat-discharge member comprises carbon, and further wherein a heat conductivity of the heat-discharge member is about 3 W/(m·K) or greater.

28. The liquid crystal display apparatus of claim 26, wherein the first external electrode and the second external electrode are connected to each other along a side face of the lamp body.
